(19) United States
(12) Patent Application Publication
(10) Pub. No.: US 2010/0162024 A1
(43) Pub. Date: Jun. 24, 2010

(54) Enabling a Charge Limited Device to Operate for a Desired Period of Time

(76) Inventors: Benjamin Kuris, Cambridge, MA (US); Steven M. Ayer, Marblehead, MA (US)

Correspondence Address: TROP, PRUNER & HU, P.C., 1616 S. VOSS RD., SUITE 750, HOUSTON, TX, 77057-2631, US

(21) Appl. No.: 12/343,543

(22) Filed: Dec. 24, 2008

(51) Int. Cl. G06F 1/32; G06F 11/30; G06F 1/26

(52) U.S. Cl. 713/340; 713/320

(57) ABSTRACT

A charge limited device that has only limited access to power can be operated to ensure a given operating time. The operating time may, for example, correspond to the time period between recharging of a battery. Instead of simply reducing power consumption, a budget is developed that enables dynamic monitoring of power consumption over that time to ensure that actual power consumption conforms to the budget.

### BACKGROUND

This relates generally to processor-based devices. This includes devices that are run by general purpose processors, devices run by graphics controllers, devices run by embedded controllers, and devices run by digital signal processors, to mention a few examples.

Conventionally, processor-based devices are designed to maximize operating life on a given amount of charge and equivalently to reduce power consumption. Thus, a variety of processor-based devices include power conservation modes where power consumption is reduced. Power conservation is particularly important in battery operated devices because they may become inoperable once battery power is fully consumed.

As used herein, a “charge limited device” is any device that operates in a mode in which it does not have effectively an unlimited power supply. For example, any device coupled to a wall plug may be considered a device that is not charge limited because, for all practical purposes, the device has available all the power it could ever use.

In contrast, charge limited devices include battery operated devices because eventually the battery charge is dissipated. Other examples of charge limited devices include devices that are run from charged capacitors and devices that are run from limited power sources that may not always be available. Examples of such limited power sources include solar powered devices.

A “charge limited power source” is a power source for a charge limited device.

### BRIEF DESCRIPTION OF THE DRAWINGS

FIG. 1 is a schematic depiction of one embodiment of the present invention;

FIG. 2 is a hypothetical graph of average power consumption versus time between charging in accordance with one embodiment of the present invention;

FIG. 3 is a flow chart for a set up sequence in accordance with one embodiment of the present invention;

FIG. 4 is a flow chart for a sequence for implementing one embodiment of the present invention;

FIG. 5 is a flow chart for an adaptation sequence in accordance with one embodiment; and

FIG. 6 is a flow chart showing a sequence for an application level operation in accordance with one embodiment.

### DETAILED DESCRIPTION

In accordance with some embodiments of the present invention, charge limited devices may be operated to achieve a necessary or desired operating life. This may be important because recharging, for example, may only be available on certain time schedules. If the charge limited device runs out of charge before the next available charging time, the device may become inoperable and its services may no longer be provided.

There are a large number of applications where it is desirable to have relatively high confidence that a charge limited device will operate for the desired operating time. One example is in connection with home monitoring applications where sensors are used to monitor a person's physical health or physical activities, to mention a few examples. Such devices may be battery powered and may be re-powered or recharged at set intervals. If the device fails in between those intervals, information about the patient's wellbeing may be lost.

In a number of cases, charge limited devices may be used for functions which depend on the amount of available charge. For example, a laptop computer may have a battery which has only a finite available power. A user may wish to use that laptop computer for a given amount of time and may wish to have some certainty that the laptop computer will function for that time period. As an example, someone taking a flight that lasts a given time may wish to ensure that the laptop computer operates for the entire flight.

Thus, in accordance with some embodiments, a budget is established. The budget specifies an available amount of charge and the time period for which the device must be operated. This information may be used to calculate an average power consumption over time. In some embodiments, constant average power consumption may be utilized. However, in other embodiments, usage models may be provided which give irregular, non-linear, or non-constant information about how power may be consumed over the time period. Then, in some embodiments, the cumulative and/or instantaneous power consumption at any given time can be compared to that usage model to determine whether an excessive amount of power is being consumed. When an excessive amount of power is being consumed, relative to the usage model, power consumption may be reduced in order to ensure that the device will operate for the intended time period.

In some cases, this reduction of power consumption or “adaptation” may be implemented in a way to reduce, to the greatest possible degree, the impact on the ongoing operation of the device. In some cases, this may be done by weighting different components or different functions differently, so that these components or functions are sacrificed only after other less critical steps are taken to reduce power consumption.

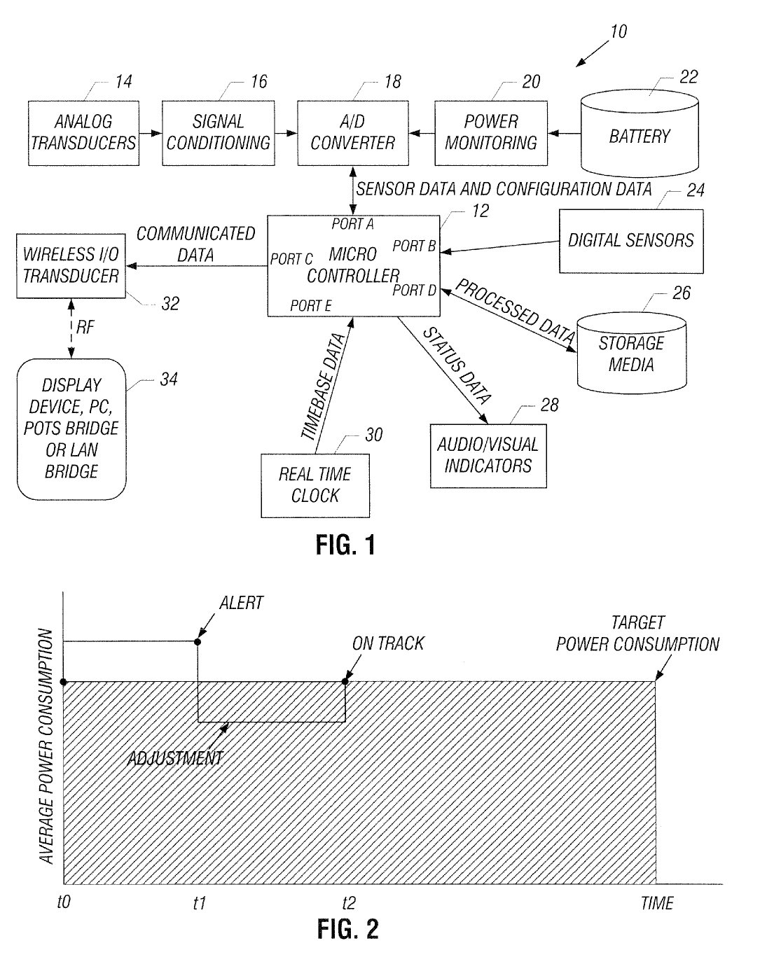

Thus, referring to FIG. 1, one example of a processor-based system that is a charge limited device is depicted. FIG. 1 is a functional diagram whose components may be realized in hardware on one or more integrated circuits including a “system-on-a-chip” and/or software running on one or more integrated circuits. The system 10 may be a home healthcare appliance. A home healthcare appliance may be used to monitor the health of a patient released from the hospital, an elderly person who needs monitoring, or a person with a chronic condition who needs some degree of monitoring, but may not need hospitalization.

The appliance 10 may include a microcontroller 12 that includes a plurality of ports. Thus, the port A communicates with an analog-to-digital converter 18. That converter 18 receives information from analog transducers 14 through signal conditioning circuits 16. The analog transducers may be any measuring device, including devices that measure the user's health characteristics, door opening or motion, or any other desired characteristic.

The converter 18 also receives an input from the battery 22 and power monitoring circuitry 20. In some embodiments, the power monitoring circuitry 20 may monitor the available battery power or the ongoing instantaneous and/or cumulative power consumption. Thus, the port A of the microcontroller 12 may receive both sensor data and configuration data.

The microcontroller 12 may also receive digital data from digital sensors 24 and may communicate with a storage media 26 to exchange process data.

Audio/visual indicators 28 may receive an output from port D of the microcontroller 12 to indicate the ongoing operation of the device 10 and to provide user feedback in some embodiments. The indicators may include indicator sounds, indicator lights, or displays.

Thus, to give a simple example, in connection with a home monitoring system, a system may be utilized to display reminder messages on the activity of a monitored person. For example, an elderly person may be monitored and sensors may be used to indicate when the monitored person is opening and closing doors. A display device may be located near a door to provide reminders as the person enters or leaves home.

Conversely, the port E may receive time based data from a real time clock 30. This provides information about what the current time is and can be used to determine whether or not the system is using power according to the usage model to achieve a desired operating life.

Port C may provide communicated data to a wireless input/output transceiver 32. The transceiver 32 communicates over a radio frequency (RF) link, for example, with a display device, a personal computer, a plain old telephone system (POTS) bridge, or a local area network (LAN) bridge, to mention a few examples. Also, while the transceiver 32 is indicated as using a radio frequency link, other wireless links may be utilized as well, including infrared, light, and sound, to mention other examples.

Ideally, the appliance 10 may be dependably operated for a desired amount of time. This ensures that the information that the device collects, in this embodiment, will be available for the entire time between recharging of the battery 22. While a battery 22 is illustrated, any charge limited power source can be used, including a charged capacitor or a solar cell.

Thus, referring to FIG. 2, the vertical axis indicates a hypothetical average power consumption and the horizontal axis indicates operating time. A target power consumption level is indicated, such that if that exact power level were consumed over the entire time period between charges, the device would be operable for the entire time between charges. However, as shown in the time between t0 and t1, hypothetically, an excessive amount of charge may be consumed.

As an example, more display time may be utilized to provide output information to the user from time t0 to t1. When this display time excess has continued for a given amount of time, an “alert” is issued at time t1, indicating that, if continued, the ability to meet the operating life between charges may be compromised. As a result, power consumption is reduced, as indicated by the “adjustment” to a power consumption level. Then at time t2, a check determines that power consumption is back “on track,” i.e. that cumulative power consumption is back in accord with the usage model. As a result, the adjustment implemented at t1 may be terminated at time t2.

Examples of adjustments may be any technique utilized to reduce short term power consumption. Thus, use of the display might be limited, wireless communications might be limited, display resolution might be varied, the amount of data that can be conveyed at any time might be varied, or any of a variety of other adaptations may be implemented.

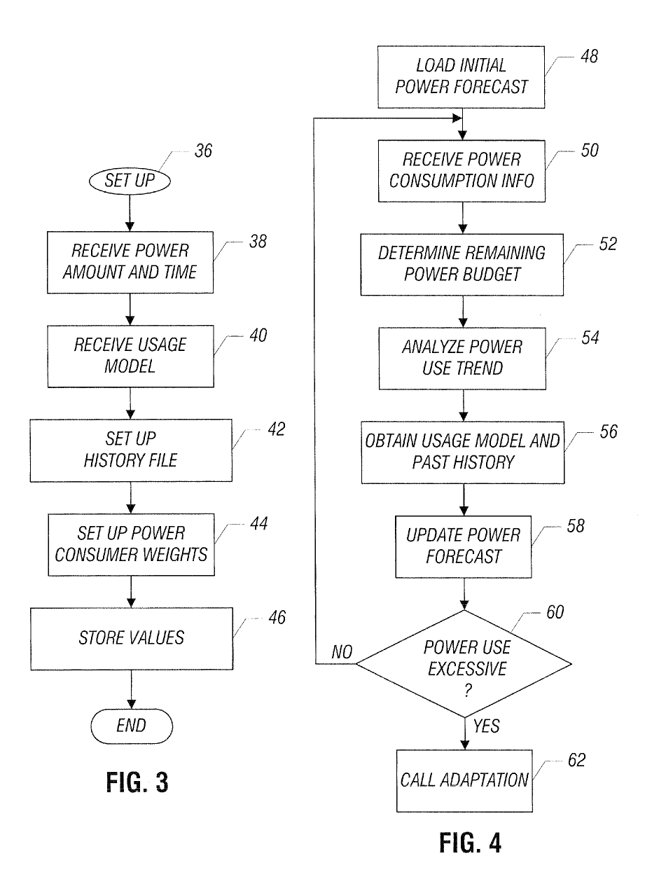

In accordance with some embodiments, the microcontroller 12 may implement sequences either in software, hardware, or firmware to achieve the desired operating life time. A software based sequence may be implemented by computer readable instructions stored, for example, on a semiconductor memory and executed by any processor, including the microcontroller 12. Initially, a setup sequence 36, shown in FIG. 3, enables the microcontroller 12 to set itself up to implement the desired operating life time assurance. While the microcontroller 12 is illustrated as being used for this purpose, other separate devices may be utilized for operating life monitoring.

Initially, the setup sequence receives the power amount and time at block 38. This may correspond to the information about how long the device must operate between charges and how much power is available before recharging. Then, the device would receive a usage model, in some embodiments, as indicated in block 40. The usage model may indicate how the power may be consumed over the operating life time. In some usage models, a linear or constant power consumption over time may be utilized. In other usage models, more or less power consumption may be allowed initially or in given times of the day and less may be allowed at other times. In any case, the usage model tells information about the rate of that power may be consumed over the desired operating time.

In addition, a history file may be set up, as indicated in block 42. The history file may be useful in supplementing the usage model. For example, in connection with an embodiment in which a sensor senses operation of doors, the history may indicate that during weekdays in the time period between 7:00 and 8:00 o'clock a large amount of power consumption may occur because of the activity in connection with going to school and work. However, the system may know that this will only be short lived and it can be accommodated later by reduced power consumption.

Thus, in some embodiments, the usage model may be supplemented with additional information based on past history. The appliance 10 may actually learn how it is being used by particular users or in particular circumstances and it may utilize that information to better accommodate its power consumption

In addition, a set of power consumption weight factors may be set up, as indicated in block 44. The weight factors may weight different operations and different components of the appliance 10 in different ways. When an adaptation is needed to reduce power consumption, a priority list may be established that reduces the performance or operation of lower priority devices and defers reducing performance or power consumption of higher priority items. Thus, in some embodiments, the impact of power consumption adaptations may be reduced.

Finally, the values that were received during the setup sequence 36 may be stored, as indicated in block 46, for subsequent use during power monitoring and power consumption control.

Referring to FIG. 4, the sequence used to actually monitor the ongoing dynamic power consumption and to call for adaptations in that power consumption is illustrated in accordance with one embodiment. The sequence may be software based, hardware based, or firmware based.

An initial power forecast may be loaded, as indicated at block 48. This forecast may, in some embodiments, be simply a default value for a given device which may be adjusted based on a particular usage model, history, or user inputs.

Then, at block 50, the actual power consumption information at any particular time is received. Next, at block 52, the remaining power budget is determined. This is the total available power minus the power already consumed to this instant of time after recharging.

Next, power use trends may be analyzed, as indicated in block 54. In some embodiments, this may involve a comparison between the cumulative, instantaneous, or recent power consumption and the usage model. Thus, in the example given in FIG. 2, in the time period from t0 to t1, the cumulative power consumption exceeds the usage model which was simply a straight line linear power consumption. In some cases, the instant power consumption may be relatively high, but because the trend has been low over time, an adjustment or adaptation may be considered to be unnecessary.

Next, in block 56, the usage model and past history may be analyzed to determine how the current power consumption and power use trend compare to other information to determine whether or not an adaptation is needed. Then, in block 58, the power forecast is updated. That is, the initial power forecast is updated based on the additional information. If it is determined that the power use is, has been, or will be excessive, as determined in diamond 60, an adaptation program may be called, as indicated in block 62.

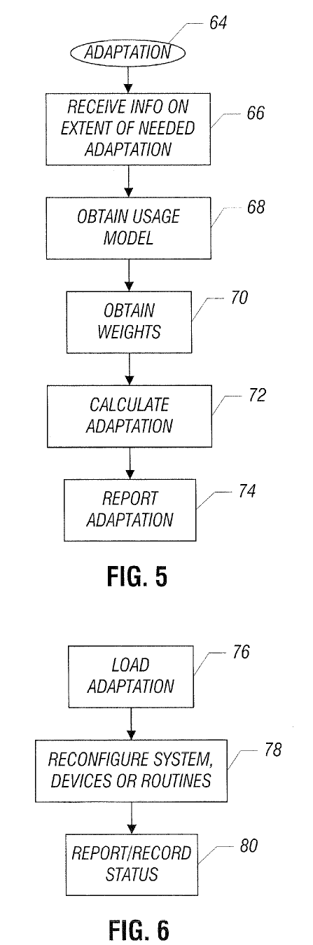

Referring to FIG. 5, the adaptation sequence 64 initially receives information on the extent of the needed adaptation 66 from the sequence of FIG. 4. The adaptation sequence may be software based, hardware based, or firmware based.

The adaptation sequence obtains the usage model in block 68, the weights in block 70, and it calculates the necessary adaptation in block 72. More particularly, the extent of the adaptation is used to determine, together with how different operations or components are weighted, which operations or components should be adversely affected by the excessive power consumption. Thus, some operations may be scaled back or precluded, while others may be unaffected because they have higher priorities. Then, in block 74, the adaptation plan is reported back to the power monitoring sequence of FIG. 4 for implementation.

In a software embodiment, application software is shown in FIG. 6. Initially, the adaptation may be loaded, as indicated in block 76. Then, in block 78, the system, devices, routines, or operations may be configured as necessary to achieve the desired adaptation plan. Status may be reported and recorded in block 80.

Thus, to give a simple example, in connection with a home monitoring system, a system may be utilized to determine how active is a monitored person. For example, an elderly person may be monitored. If the person is no longer active, that person may need more onsite monitoring. Sensors may be used to indicate when the monitored user is opening and closing doors.

After recharging the monitoring device, the amount of necessary operating time until the next charge and a base amount of power that is available from the power source is determined. Then a usage model is used to determine how it would be expected that the available charge would be consumed over time.

Once the power monitoring begins, an alert may be issued that an abnormal amount of display activity may have been encountered because of a lot of activity at the front door. It may be determined that, given the passage of time between charges, too much display time has already been utilized. Thus, an adaptation may be ordered to reduce power consumption. For example, the adaptation may be to reduce wireless communication to save power if wireless communications are given a lower priority than other power consuming operations, such as display.

After an amount of time, it may be determined that power consumption is down and is now back within the usage model. As a result, the power saving techniques may be terminated and normal operation may proceed.

In some cases, the system may encounter a surplus of available power, indicating that, at the next instance when power consumption is excessive, it may not be necessary to take an adaptation because even though short term power consumption may be up, the appliance is still well within its power consumption goals for the given time period.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
obtaining a measure of available power for a given period of time for a charge limited device; and
monitoring ongoing power consumption to determine whether power consumption needs to be altered to ensure operation for said period of time.

2. The method of claim 1 wherein obtaining a measure of available power includes obtaining an amount of charge available from the power source and an operation time that needs to be achieved using that power source.

3. The method of claim 1 including receiving a usage model that indicates how power may be consumed over that time.

4. The method of claim 3 including modifying said usage model based on past history.

5. The method of claim 3 including determining whether power consumption deviates from said model and, if so, reducing power consumption.

6. The method of claim 5 including reducing power consumption until the cumulative power consumption is back in accordance with the usage model.

7. The method of claim 3 including assigning different weights to different activities.

8. The method of claim 7 including reducing power consumption by selecting activities to curtail based on weighting of different activities.

9. The method of claim 1 including obtaining a measure of available battery power.

10. The method of claim 1 including ensuring that the device can operate for a predetermined amount of time on the available power.

11. An apparatus comprising:
a charge limited power source; and
a device to obtain a measure of available power from said power source for a given period of time and to monitor ongoing power consumption to determine whether power consumption needs to be altered to ensure operation for said period of time.

12. The apparatus of claim 11 wherein said apparatus is a home healthcare appliance.

13. The apparatus of claim 11 wherein said power source is a battery.

14. The apparatus of claim 11, said device to obtain a measure of available power including an amount of charge available from the power source and an operation time that needs to be achieved using that power source.

15. The apparatus of claim 11, said device to use a usage model that indicates how power may be consumed over said time.

16. The apparatus of claim 15, said device to modify said usage model based on past history.

17. The apparatus of claim 16, said device to determine when power consumption deviates from said model and, in response, to reduce power consumption.

18. The apparatus of claim 17, said device to reduce power consumption until a cumulative power consumption is back in accordance with the usage model.

19. The apparatus of claim 11 said device to ensure that said apparatus operates for a said time.

20. The apparatus of claim 18, said device to use weighting of different operations to determine which operations to curtail to conserve power.
